(19) United States
(12) Patent Application Publication
(10) Pub. No.: US 2007/0112129 A1
(43) Pub. Date: May 17, 2007

(54) Polyurethane dispersion comprising siloxane groups

(75) Inventors: Ulrike Licht, Mannheim (DE); Markus Antonietti, Bergholz-Rehbrucke (DE); Katharina Landfester, Ulm (DE)

Correspondence Address: OBLON, SPIVAK, MCCLELLAND, MAIER & NEUSTADT, P.C., 1940 DUKE STREET, ALEXANDRIA, VA, 22314, US

(73) Assignees: BASF Aktiengesellschaft, Ludwigshafen (DE); Mas-Planck-Gesellschaft Zur Förd Der Wissen. E.V., München (DE)

(21) Appl. No.: 10/578,178

(22) PCT Filed: Oct. 30, 2004
(86) PCT No.: PCT/EP04/12340

§ 371 Date: May 4, 2006

(30) Foreign Application Priority Data
Nov. 4, 2003 (DE) 103 52 101.1

(51) Int. Cl. C08G 18/08

(52) U.S. Cl. 524/589

(57) ABSTRACT

Aqueous dispersion of a polyurethane, obtainable by reacting polyisocyanates and isocyanate-reactive compounds in miniemulsion, wherein the isocyanate-reactive compounds are at least in part polysiloxanes of the formula I 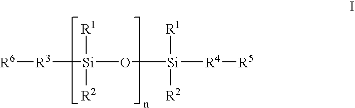 where
R¹ and R² independently of one another are a monovalent hydrocarbon radical having not more than 20 carbon atoms, which if appropriate may also contain heteroatoms such as O or N,
R³ and R⁴ independently of one another are a single bond or a divalent hydrocarbon radical having not more than 20 carbon atoms, which if appropriate may also contain heteroatoms such as O or N,
R⁵ and R⁶ independently of one another are a group OH, SH, NH₂ or NHR⁷ and R⁷ is a monovalent hydrocarbon radical having not more than 20 carbon atoms, which if appropriate may also contain heteroatoms such as O or N,
   and n is an integer from 1 to 100.

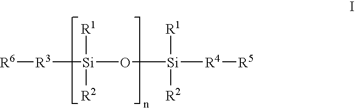

The invention relates to an aqueous dispersion of a polyurethane, obtainable by reacting polyisocyanates and isocyanate-reactive compounds in miniemulsion, wherein the isocyanate-reactive compounds are at least in part polysiloxanes of the formula I

where

R¹ and R² independently of one another are a monovalent hydrocarbon radical having not more than 20 carbon atoms, which if appropriate may also contain heteroatoms such as O or N,
R³ and R⁴ independently of one another are a single bond or a divalent hydrocarbon radical having not more than 20 carbon atoms, which if appropriate may also contain heteroatoms such as O or N,
R⁵ and R⁶ independently of one another are a group OH, SH, NH₂ or NHR⁷ and R⁷ is a monovalent hydrocarbon radical having not more than 20 carbon atoms, which if appropriate may also contain heteroatoms such as O or N,
and n is an integer from 1 to 100.

Polyurethanes are normally prepared by reaction of their starting compounds (isocyanates and isocyanate-reactive compounds) in an organic solvent. Dispersing the resulting polyurethane in water gives what is called a secondary dispersion.

Polyurethane dispersions can also be obtained directly by reaction of the starting compounds in aqueous phase (primary dispersions).

This is possible by the process of polymerization in miniemulsion described in WO 02/064657.

In that process the starting compounds are emulsified in water in the presence of small amounts of a hydrophobic compound having a water solubility of less than 10⁻⁷ g/l water (at 21° C.).

The size of the droplets is adjusted by known methods to 50 to 500 nm. As a result of the presence of the hydrophobic substance the effect of Ostwald ripening (growth of the droplets until phase separation occurs) does not arise.

Instead, in the droplets, the starting compounds can be reacted to polyurethanes, with the droplet size remaining more or less the same. In this way polyurethane primary dispersions are obtained.

The desire is for polyurethane dispersions whose particles are as small as possible. The polyurethane dispersions ought to contain levels as low as possible of low molecular mass constituents, which can subsequently migrate from the resulting films.

The polyurethane dispersions ought to have a high stability and good performance properties.

An object of the present invention was therefore to improve the stability and the performance properties of polyurethane primary dispersions obtainable in miniemulsion.

Accordingly the aqueous polyurethane dispersion defined at the outset has been found.

Also found has been a process for its preparation, and also the use of the dispersion as, for example, a foam stabilizer.

The polyurethane dispersions of the present specification are primary dispersions obtainable by reacting isocyanates and isocyanate-reactive compounds in aqueous phase in miniemulsion, as described in WO 02/064657.

The isocyanates and the isocyanate-reactive compounds (for short: starting compounds) are for that purpose emulsified in water by means of surface-active compounds, e.g., emulsifiers or protective colloids.

The accompanying use of hydrophobic compounds as costabilizers is essential.

These costabilizers have a water solubility of preferably less than 10⁻⁵, more preferably less than 10⁻⁶, very preferably less than 10⁻⁷ g/liter water at 21° C., 1 bar.

The amount of the costabilizers can be, for example, from 0.1 to 10 parts by weight, in particular from 1 to 3 parts by weight per 100 parts by weight of starting compounds.

Examples of suitable costabilizers include hydrocarbons such as hexadecane, halogenated hydrocarbons, silanes, siloxanes, hydrophobic oils (olive oil) or else starting compounds for the polyurethane, provided they have the necessary hydrophobicity.

Also suitable in particular are the polysiloxanes of the formula I. Preferred polysiloxanes of the formula I therefore have the above-indicated solubility of the costabilizers. In that case there is no need for other costabilizers. In that case the polyurethane does not contain any costabilizers which can migrate from the resulting coatings.

In particular at least 50% by weight of the costabilizers can be those of the formula I.

The particle size of the emulsified droplets of the starting compounds is preferably from 50 to 500 nm.

The particle size can be adjusted by known methods such as homogenization in high-pressure homogenizers or application of ultrasound.

The reaction of the starting compounds to the polyurethane can take place in a known way at elevated temperature. e.g., from 20 to 120° C., preferably 60 to 100° C.

Like the emulsion of the starting compounds, the polyurethane dispersion obtained has a droplet size of preferably from 50 to 500 nm, more preferably from 100 to 300 nm.

In accordance with the invention the isocyanate-reactive compounds are at least in part polysiloxanes of the formula I.

In this formula R¹ and R² independently of one another are a monovalent hydrocarbon radical having not more than 20 carbon atoms, which if appropriate may also contain heteroatoms such as O or N atoms.

The hydrocarbon radical may contain oxygen atoms, as, for example, ether group or hydroxyl group.

In particular R¹ and R² are an alkyl group, more preferably a C₁-C₁₀ alkyl group, very preferably a C₁-C₄ alkyl group.

In particular R¹ and R² are a methyl group.
R³ and R⁴ in the formula I may independently of one another be a single bond or a divalent hydrocarbon radical having not more than 20 carbon atoms, which if appropriate may also contain heteroatoms such as O or N.

The case in which R³ and R⁴ are a single bond is to be understood to the effect that R³ and/or R⁴ in formula I above are omitted and R⁵ and/or R⁶ are attached directly to the respective silicon atom.

If R³ and R⁴ are a hydrocarbon radical, that radical may contain heteroatoms, as, for example, ether group, hydroxyl group or primary or secondary amino groups.

Preferably R³ and R⁴ independently of one another are a single bond or a C₁-C₂₀ alkyl group, in particular a C₁-C₁₀ alkylene group.

More preferably R³ and R⁴ independently of one another are a single bond or a C₁-C₆ alkylene group.
R⁵ and R⁶ independently of one another are a group OH, SH, NH₂ or NHR⁷. R⁷ here has the definition of R¹. In particular R⁷ is an alkyl group, more preferably a C₁-C₁₀ alkyl group, very preferably a C₁-C₄ alkyl group.

Preferably R⁵ and R⁶ are a hydroxyl group (OH).

The variable n is an integer from 1 to 100, preferably from 1 to 50, more preferably from 5 to 50, and very preferably from 5 to 40.

As preferred compounds of the formula I mention may be made, for example, of compounds of the formula II 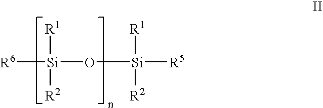
in which R⁶ and R⁵ are a hydroxyl group and R¹ and R² are a C₁-C₄ alkyl group.

Preferred compounds of the formula I are also those in which R⁶ and R⁵ are a hydroxyl group, R¹ and R² are a C₁-C₄ alkyl group, and R³ and R⁴ are a C₁-C₆ alkylene group.

Compounds of this kind are available, for example, under the name Tegomer® from Goldschmidt.

All in all the polyurethane has been preferably synthesized from:
a) polyisocyanates,
b) polyols of which
b₁) 10 to 100 mol %, based on the total amount of the polyols (b), have a molecular weight of from 500 to 5000 g/mol,
b₂) 0 to 90 mol %, based on the total amount of the polyols (b), have a molecular weight of from 60 to 500 g/mol,
c) monomers other than the monomers (a) and (b), having at least one isocyanate group or at least one group which is reactive toward isocyanate groups, and further carrying at least one hydrophilic group or one potentially hydrophilic group,
d) if appropriate further compounds, other than the monomers (a) to (c), having at least 2 isocyanate-reactive groups, of which at least one group is a primary or secondary amino group or a mercapto group,
e) if appropriate, monovalent compounds, other than the monomers (a) to (d), having a reactive group which is an alcoholic hydroxyl group, a primary or secondary amino group or an isocyanate group.

Mention should be made in particular as monomers (a) of diisocyanates X(NCO)₂, where X is an aliphatic hydrocarbon radical having 4 to 15 carbon atoms, a cycloaliphatic or aromatic hydrocarbon radical having 6 to 15 carbon atoms or an araliphatic hydrocarbon radical having 7 to 15 carbon atoms. Examples of such diisocyanates are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)-propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomer, and mixtures of these compounds.

Diisocyanates of this kind are available commercially.

Of particular significance as mixtures of these isocyanates are the mixtures of the respective structural isomers of diisocyanatotoluene and diisocyanatodiphenylmethane; in particular the mixture of 80 mol % 2,4-diisocyanatotoluene and 20 mol % 2,6-diisocyanatotoluene is suitable. Also advantageous in particular are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixing ratio of the aliphatic to aromatic isocyanates being from 4:1 to 1:4.

Additionally polyisocyanates having more than 2 isocyanate groups can be used. Suitable examples include isocyanates and biurets of, for example, hexamethylene diisocyanate.

For the synthesis of the polyurethanes it is possible to use as compounds, in addition to those mentioned above, isocyanates which besides the free isocyanate groups carry further, blocked isocyanate groups, e.g., uretdione groups.

From the standpoint of effective film formation and elasticity, suitable polyols (b) include principally polyols (b1) of relatively high molecular weight, having a molecular weight of from about 500 to 5000, preferably from about 1000 to 3000 g/mol. This is the number-average molar weight Mn. Mn is obtained by determining the number of end groups (OH number).

The polyols (b1) can be polyester polyols, which are known, for example, from Ullmanns Encyklopädie der technischen Chemie, 4th edition, Volume 19, pp. 62 to 65. Preference is given to using polyester polyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cycloaliphatic, araliphatic, aromatic or heterocyclic and can if appropriate be substituted, by halogen atoms for example, and/or unsaturated. Examples thereof which may be mentioned include: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preference is given to dicarboxylic acids of the general formula HOOC—(CH₂)_{y}—COOH, where y is a number from 1 to 20, preferably an even number from 2 to 20, e.g., succinic acid, adipic acid, sebacic acid, and dodecanedicarboxylic acid.

Suitable polyhydric alcohols include for example ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from 1 to 20, preferably an even number from 2 to 20. Examples thereof are ethylene glycol, butane-1 ,4-diol, hexane-1 ,6-diol, octane-1 ,8-diol, and dodecane-1 ,12-diol. Preference is given additionally to neopentyl glycol.

Also suitable if appropriate are polycarbonate diols, such as are obtained, for example, by reacting phosgene with an excess of the low molecular mass alcohols specified as synthesis components for the polyester polyols.

If appropriate it is also possible to use lactone-based polyester polyols, which are homopolymers or copolymers of lactones, preferably adducts of lactones with suitable difunctional starter molecules, said adducts containing terminal hydroxyl groups. Suitable lactones include preferably those derived from compounds of the general formula HO—(CH₂)_{z}—COOH, where z is a number from 1 to 20 and where one hydrogen atom in a methylene unit may also be substituted by a C₁to C₄ alkyl radical. Examples are e-caprolactone, β-propiolactone, g-butyrolactone and/or methyl-e-caprolactone and also mixtures thereof. Suitable starter components are, for example, the low molecular mass dihydric alcohols specified above as a synthesis component for the polyester polyols. The corresponding polymers of e-caprolactone are particularly preferred. Lower polyester diols or polyether diols can also be used as starters for preparing the lactone polymers. Instead of the polymers of lactones it is also possible to use the corresponding, chemically equivalent polycondensates of the hydroxycarboxylic acids corresponding to the lactones.

Polyether polyols are obtainable in particular by polymerizing ethylene oxide, propylene oxide, butylene oxide, tetrahydrofuran, styrene oxide or epichlorohydrin with itself, in the presence of BF₃, for example, or by adducting of these compounds, if appropriate in a mixture or in succession, with starting components containing reactive hydrogen atoms, such as alcohols or amines, e.g., water, ethylene glycol, propane-1,2-diol, propane-1,3-diol, 2,2-bis(4-hydroxyphenyl)propane or aniline. Particular preference is given to polypropylene oxide, polytetrahydrofuran with a molecular weight of from 240 to 5000, and in particular from 500 to 4500.

b₁) embraces only polyether polyols of which less than 20% by weight is composed of ethylene oxide. Polyether diols with at least 20% by weight are hydrophilic polyether diols, which are included in monomers c).

If appropriate it is also possible to use polyhydroxy olefins, preferably those having 2 terminal hydroxyl groups, e.g., α-ω-dihydroxypolybutadiene, α,-ωdihydroxypolymethacrylic esters or α,-ω-dihydroxypolyacrylic esters as monomers (c1). Such compounds are known for example from EP-A 0622378. Further suitable polyols are polyacetals, polysiloxanes, and alkyd resins.

The hardness and the modulus of elasticity of the polyurethanes can be increased by using as diols (b) besides the diols (b1) low molecular weight diols (b2) having a molecular weight of from about 60 to 500, preferably from 62 to 200 g/mol.

As monomers (b2) use is made above all of the synthesis components of the short-chain alkane diols specified for the preparation of polyester polyols, preference being given to the unbranched diols having 2 to 12 carbon atoms and an even number of carbon atoms, and also pentane-1,5-diol and neopentyl glycol.

Suitable polyols b₂) include for example ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)cyclohexane, 2-methylpropane-1,3-diol, methylpentanediols, and also diethylene glycol, triethylene glycol, tetraethylene glycol, polyethylene glycol, dipropylene glycol, polypropylene glycol, dibutylene glycol, and polybutylene glycols. Preference is given to alcohols of the general formula HO—(CH₂)ₓ—OH, where x is a number from, 1 to 20, preferably an even number from 2 to 20. Examples thereof are ethylene glycol, butane-1,4-diol, hexane-1,6-diol, octane-1,8-diol, and dodecane-1,12-diol. Preference is given additionally to neopentyl glycol.

Preferably the fraction of the polyols (b₁), based on the total amount of the diols (b), is from 10 to 100 mol % and the fraction of the monomers (b₂), based on the total amount of the diols (b), is from 0 to 90 mol %. With particular preference the ratio of the diols (b1) to the monomers (b2) is from 0.1:1 to 5:1, more preferably from 0.2:1 to 2:1.

In order to improve the dispersibility of the polyurethanes in water it is possible for the polyurethanes to comprise, as a synthesis component, monomers (c), which are other than components (a), (b), and (d), and which carry at least one isocyanate group or at least one group which is reactive toward isocyanate groups and additionally at least one hydrophilic group or one group which can be converted into a hydrophilic group.

Hydrophilic monomers of this kind, although they can be used, are nevertheless not necessary for a stable miniemulsion. The amount of ionic groups is preferably less than 100 mmol per 1000 g of polyurethane, and with particular preference the polyurethane contains no monomers c).

The monomers (d), which are other than the monomers (a) to (c) and which if appropriate are also constituents of a polyurethane, serve in general for crosslinking or for chain extension.

Alcohols having a functionality of greater than 2, which may be used in order to set a certain degree of branching or crosslinking, are trimethylolpropane, glycerol or sugars, for example.

Additionally suitable are monoalcohols which in addition to the hydroxyl group carry a further isocyanate-reactive group, such as monoalcohols having one or more primary and/or secondary amino groups, monoethanolamine for example.

Polyamines having 2 or more primary and/or secondary amino groups are used above all when the chain extension and/or crosslinking is to take place in the presence of water, since amines generally react with isocyanates more quickly than do alcohols or water. This is frequently necessary when aqueous dispersions of crosslinked polyurethanes or polyurethanes with a high molar weight are desired.

Amines suitable for this purpose are generally polyfunctional amines from the molar weight range from 32 to 500 g/mol, preferably from 60 to 300 g/mol, which contain at least two amino groups, selected from the group consisting of primary and secondary amino groups. Examples thereof are diamines such as diaminoethane, diaminopropanes, diaminobutanes, diaminohexanes, piperazine, 2,5-dimethylpiperazine, amino-3-aminomethyl-3,5,5-trimethylcyclohexane(isophoronediamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, e.g., in the form of the corresponding ketimines (see, e.g., CA-A 1 129 128), ketazines (cf., e.g., U.S. Pat, No. 4,269,748) or amine salts (see U.S. Pat. No. 4,292,226). Oxazolidines as well, as used for example in U.S. Pat. No. 4,192,937, are blocked polyamines which can be used for preparing the polyurethanes of the invention, for the chain extension of the prepolymers.

Monomers (e), used as well if appropriate, are monoisocyanates, monoalcohols, and monoprimary and monosecondary amines. Generally speaking their fraction is not more than 10 mol %, based on the total molar amount of the monomers. These monofunctional compounds normally carry further functional groups such as olefinic groups or carbonyl groups and serve to introduce functional groups into the polyurethane that allow the polyurethane to be dispersed and/or crosslinked or subjected to further polymer-analogous reaction. Monomers suitable for this purpose include those such as isopropenyl-a,a-dimethylbenzyl isocyanate (TMI) and esters of acrylic or methacrylic acid such as hydroxyethyl acrylate or hydroxyethyl methacrylate.

Coatings having a particularly good profile of properties are obtained above all when essentially only aliphatic diisocyanates, cycloaliphatic diisocyanates or araliphatic diisocyanates are used as monomers (a).

The polysiloxanes can be monomers b) or d), depending on the nature of the reactive groups (R⁵ and R⁶) and on the height of the molecular weights.

The inclusion of polysiloxanes improves the stability of the miniemulsion. The dispersions obtained are very fine.

For an improvement of this kind in stability an amount of just preferably at least 0.5% by weight, more preferably at least 1% by weight, in particular at least 2% by weight or 5% by weight, based on the polyurethane, is sufficient.

The amount of polysiloxanes of the formula I may total up to 90% by weight, in particular up to 70% by weight, more preferably up to 50% by weight.

Preferably the amount is, for example, from 1 to 70% by weight or from 2 to 50% by weight, in particular from 5 to 30% by weight, based on the polyurethane.

Normally the components (a) to (e) and their respective molar amounts are chosen so that the ratio A:B, where
A is the molar amount of isocyanate groups and
B is the sum of the molar amount of the hydroxyl groups and the molar amount of the functional groups which are able to react with isocyanates in an addition reaction,

is from 0.5:1 to 2:1, preferably from 0.8:1 to 1.5, more preferably from 0.9:1 to 1.2:1. With very particular preference the ratio A:B is as close as possible to 1:1.

The monomers (a) to (e) employed carry on average normally from 1.5 to 5, preferably from 1.9 to 2.1, more preferably 2.0 isocyanate groups and, respectively, functional groups which are able to react with isocyanates in an addition reaction.

The polyaddition of the components (a) to (e) for preparing the polyurethane takes place preferably at reaction temperatures of up to 180° C., preferably up to 100° C., under atmospheric pressure, under the autogenous pressure or under the overpressure of an inert gas, e.g. nitrogen or carbon dioxide.

The preparation of the miniemulsions is already known and has been described above.

At this point reference may be made additionally to the following particular embodiments:

Preparation of the Polysiloxanes

The polysiloxanes of the formula I can be prepared from their starting compounds in the same aqueous phase in which the miniemulsion is formed (in situ).

The preparation can take place before, during or after the preparation of the miniemulsion.

In particular it is possible for a miniemulsion to be prepared from the starting compounds of the polyurethanes and for the reaction to form the polysiloxanes and polyurethanes to take place in said miniemulsion.

Hybrid Systems

In addition to the polyurethane, the aqueous dispersions may contain further polymers, in particular polymers obtainable by free-radical addition polymerization. The systems in question are preferably hybrid systems.

In these hybrid systems the polyurethane and polymer are present in the dispersed particles in a mixture and are preferably partly attached to one another.

For the preparation of the hybrid systems it is possible for the starting compounds of the polyurethane and the monomers of the polymer obtainable by free-radical addition polymerization to be polymerized in the same miniemulsion, as described, for example, in DE-A 10241294 (PF 53898). In that case the hybrid systems are obtained directly by polymerization in miniemulsion.

In the case of these hybrid systems the above weight fractions of the polysiloxane relate not to the polyurethane alone but rather to the entire hybrid system obtained in miniemulsion.

Preferably at least 60% by weight of the polymer obtainable by free-radical addition polymerization is composed of C₁-C₂₀ alkyl (meth)acrylates. The fraction of the polyurethane in the hybrid systems can be, for example, from 5 to 95% by weight. The fraction of the other polymer adds up, correspondingly, to 100% and may likewise be from 5 to 95% by weight.

The stability of the inventive dispersions of the polyurethane (or else hybrid system) is good.

The dispersions have virtually no tendency to agglomerate or sediment.

The dispersion particles obtained are finer than those of polyurethanes without these polysiloxanes.

The dispersions have good performance properties, in particular an effective adhesion to customary substances of metal, plastic or wood.

The dispersions are highly suitable as binders for adhesives, sealants or coating compositions.

The dispersions are also highly suitable as binders for cosmetic preparations, e.g., hairspray, styling gel, nail varnish, makeup or shampoo. In the case of cosmetic preparations the amount of the polysiloxanes of the formula I is preferably from 0.1 to 20% by weight, but with particular preference at least 0.5 to 10% by weight.

They are particularly suitable also as foam stabilizers, for polyurethane foams for example. In the case of use as a foam stabilizer an amount of at least 10% by weight, more preferably at least 20% by weight, and not more than 80% by weight, more preferably not more than 60% by weight of polysiloxane of the formula I in the polyurethane is advantageous.

### EXAMPLE

Reactants and Abbreviations

IPDI: Isophorone diisocyanate

Tegomers:

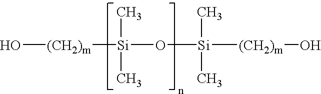

Tegomer 2111: n=10

Tegomer 2311: n=30

PU: Polyurethane

PS: Polystyrene

PA: Polyacrylate

DDDBr: Didodecylmethammonium bromide

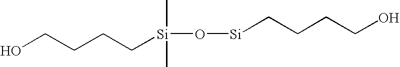

M2BOH:

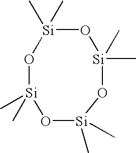

D4:

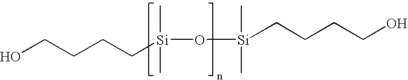

PDMS:

### Example 1

0 g of a monomer mixture of 0.5355 g of IPDI and 5.4645 g of Tegomer 2311 are mixed with 200 mg of hexadecane and added to a solution of 200 mg of sodium dodecyl sulfate and 24 g of water. After one hour of stirring with the magnetic stirrer at its highest setting, 50 mg of dioctyltin dilaurate catalyst are added, and the miniemulsion is then prepared by two minutes of ultrasonication (Branson Sonifier W450 Digital) at an amplitude of 90% (Branson Sonifier W450) with ice cooling. Subsequently the temperature is raised to 60° C. The reaction is at an end after 2 hours.
Particle size: 194 nm
Solids content: 19.00%
Molecular weight: 51.3·10³ g/mol

### Example 2

Like Example 1; the monomer mixture consists of 1.3456 g of IPDI and 4.6544 g of Tegomer 2111.
Particle size: 198 nm
Solids content: 19.96%
Molecular weight: 40.5·10³ g/mol

### Example 3

Like Example 1; with dibutyltin dilaurate (DBTL) as catalyst.
Particle size: 434 nm
Solids content: 20.41%
Molecular weight: 20.2·10³ g/mol

### Example 4

0 g of a monomer mixture of 0.6744 g of IPDI, 5.166 g of Tegomer 2311 and 0.152 g of dodecanediol are mixed with 200 mg of hexadecane and added to a solution of 200 mg of sodium dodecyl sulfate and 24 g of water. After one hour of stirring with the magnetic stirrer at its highest setting, 50 mg of dioctyltin dilaurate catalyst are added, and the miniemulsion is then prepared by two minutes of ultrasonication (Branson Sonifier W450 Digital) at an amplitude of 90% (Branson Sonifier W450) with ice cooling. Subsequently the temperature is raised to 60° C. The reaction is at an end after 2 hours.
Particle size: 222 nm
Solids content: 19.86%
Molecular weight: 51.3·10³ g/mol

### Example 5

Like Example 4, with a monomer mixture of 1.8840 g of IPDI, 3.2584 g of Tegomer 2111 and 0.8576 g of dodecanediol.
Particle size: 116 nm
Solids content: 10.98%
Molecular weight: 51.3·10³ g/mol

### Example 6

(Preparation of a Hybrid System):

6 g of a monomer mixture of 0.2678 g of IPDI, 2.7323 g of Tegomer 2311 and 3 g of styrene are mixed with 200 mg of hexadecane and added to a solution of 200 mg of sodium dodecyl sulfate and 24 g of water. After one hour of stirring with the magnetic stirrer at its highest setting, 25 mg of dioctyltin dilaurate catalyst are added, and the miniemulsion is then prepared by two minutes of ultrasonication (Branson Sonifier W450 Digital) at an amplitude of 90% (Branson Sonifier W450) with ice cooling. Subsequently the temperature is raised to 60° C. After 3 hours of reaction at 60° C. the temperature is raised to 72° C. and 50 mg of KPS (potassium persulfate) are added. The reaction is at an end after 4 hours.
Particle size: 85 nm
Solids content: 18.37%
Molecular weight (of the PU): 55.6·10³ g/mol
Molecular weight (of the PS): 513·10³ g/mol

### Example 7

Preparation of the Polysiloxane

0.4 g of didodecylmethammonium bromide and 2 g of 1 N NaOH are added to 7.217 g of D4 and 2.753 g of M2BOH. A suspension is obtained by stirring. The reaction takes place at a temperature of 60° C. (72 h reaction time). The molecular weight of the PDMS formed is 2000·10³ g/mol (determined by GPC). After the end of the reaction the product is washed three times.

Preparation of the Hybrid System

The miniemulsion is prepared using 2.842 g of PDMS, 0.158 g of IPDI and 3 g of styrene. After one hour of stirring with the magnetic stirrer at its highest setting, 25 mg of dioctyltin dilaurate catalyst are added, and the miniemulsion is then prepared by two minutes of ultrasonication (Branson Sonifier W450 Digital) at an amplitude of 90% (Branson Sonifier W450) with ice cooling. Subsequently the temperature is raised to 60° C. After 3 hours of reaction at 60° C. the temperature is raised to 72° C. and 40 mg of KPS are added. The reaction is at an end after 4 hours.
Particle size: 75 nm
Molecular weight (PS): 310·10³ g/mol

### Example 8

Like Example 7; monomer mixture of 2.842 g of PDMS, 0.158 g of IPDI and 3 g of butyl acrylate.
Particle size: 97 nm
Molecular weight (PU): 40·10³ g/mol
Molecular weight (PA): 290·10³ g/mol

### Example 9

10.7 g of Tegomer H—Si 2111,14.96 g of melted cyclohexanedimethanol and 15.8 g of IPDI are mixed and the mixture is stirred with 96.6 g of DI water containing 3.7 g of Texapon NSO, using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 25%,
Particle size: 239 nm

### Example 10

0.5 g of Tegomer H—Si 2111, 2.19 g of melted cyclohexanedimethanol, 3.18 g of polyetherol Lupranol VP 9343 and 4.2 g of IPDI are mixed and the mixture is stirred with 27.4 g of DI water containing 1.6 g of Steinapol NLS, using a magnetic stirrer. Then sonication is carried out with a Branson Sonifier W 450 at 100% amplitude and 50% pulse for 90 s, with ice cooling. The sample is admixed with 2 drops of DBTL and the mixture is heated at 60° C. for 4 h. After filtration over 40 my the solids content is 29%,
Particle size: 104 nm

### Example 11

### Comparative Example

PolyTHF1000 instead of Tegomer H—Si 2111:

2.85 g of PolyTHF1000, 2.06 g of melted cyclohexanedimethanol, 2.99 g of polyetherol Lupranol VP 9343 and 3.96 g of IPDI are mixed and the mixture is stirred with 26.9 g of DI water containing 1.6 g of Steinapol NLS, using a magnetic stirrer. Then sonication is carried out with a Branson Sonifier W 450 at 100% amplitude and 50% pulse for 90 s, with ice cooling. The sample is admixed with 2 drops of DBTL and the mixture is heated at 60° C. for 4 h. After filtration over 40 my the solids content is 28.6%,
Particle size: 217 nm

### Example 12

32.1 g of Tegomer H—Si 2111, 7.0 g of butane-1,4-diol, 1.6 g of hexadecane and 25.9 g of IPDI are mixed and the mixture is stirred with 108.4 g of DI water and 17.4 g of Steinapol NLS at RT using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 31.2%,
Particle size: 235 nm

### Example 13(Comparative)

35.2 g of pTHF1000, 6.3 9 of butane-1,4-diol, 1.6 g of hexadecane and 23.47 g of IPDI are mixed and the mixture is stirred with 108.4 9 of DI water and 17.4 g of Steinapol NLS at RT using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 31%,
Particle size: 265 nm

### Example 14

22.3 g of Tegomer H—Si 2111, 12.7 9 of 3-methylpentane-1,5-diol, 1.6 9 of hexadecane and 30 g of IPDI are mixed and the mixture is stirred with 108.4 g of DI water and 17.4 g of Steinapol NLS at RT using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 31.8%,
Particle size: 209 nm

### Example 15(Comparative)

25 g of polyester diol (OHN: 105 mg KOH/g), 11.6 g of 3-methylpentane-1,5-diol, 1.6 g of hexadecane and 27.5 g of IPDI are mixed and the mixture is stirred with 108.4 g of DI water and 17.4 g of Steinapol NLS at RT using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 31%,
Particle size: 294 nm

### Example 16

32.9 g of Tegomer H—Si 2111, 7.2 g of butane-1,4-diol and 26.6 g of IPDI are mixed and the mixture is stirred with 108.4 g of DI water and 17.4 g of Steinapol NLS at RT using a magnetic stirrer. Then sonication is carried out with a Branson Sonifier W 450 at 100% amplitude and 50% pulse for 4 minutes, with ice cooling. The sample is admixed with 6 drops of DBTL and the mixture is heated at 60° C. for 5 h. After filtration over 40 my the solids content is 29%,
Particle size: 269 nm

1. An aqueous dispersion of a polyurethane, obtained by reacting polyisocyanates and isocyanate-reactive compounds in miniemulsion, wherein the isocyanate-reactive compounds comprise, at least in part, polysiloxanes of the formula I 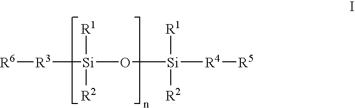
wherein
R¹ and R² independently of one another are a monovalent hydrocarbon radical comprising not more than 20 carbon atoms, which, optionally, may comprise at least one heteroatom,
R³ and R⁴ independently of one another are a single bond or a divalent hydrocarbon radical comprising not more than 20 carbon atoms, which, optionally, may comprise at least one heteroatom,
R⁵ and R⁶ independently of one another are OH, SH, NH₂ or NHR⁷, wherein R⁷ is a monovalent hydrocarbon radical comprising not more than 20 carbon atoms, which, optionally, may comprise at least one heteroatom,
and n is an integer from 1 to 100.

2. The aqueous dispersion according to claim 1, wherein
R¹ and R² independently of one another are a C₁-C₄ alkyl group,
R³ and R⁴ independently of one another are a single bond or a C₁-C₆ alkylene group, and
R⁵ and R⁶ independently are OH, SH, NH₂ or NHR⁷, and wherein R⁷ is a C₁-C₄ alkyl radical.

3. The aqueous dispersion of claim 1, wherein the polyurethane has been synthesized from
a) polyisocyanates,
b) polyols of which
b₁) 10 to 100 mol %, based on the total amount of the polyols (b), have a molecular weight of from 500 to 5000 g/mol,
b₂) 0 to 90 mol %, based on the total amount of the polyols (b), have a molecular weight of from 60 to 500 g/mol,
c) monomers other than the monomers (a) and (b), comprising at least one isocyanate group or at least one group which is reactive toward isocyanate groups, and further carrying at least one hydrophilic group,
d) optionally, at least one further compound, other than the monomers (a) to (c), comprising at least 2 isocyanate-reactive groups, of which at least one group is a primary or secondary amino group or a mercapto group,
e) optionally, at least one monovalent compound, other than the monomers (a) to (d), comprising a reactive group which is an alcoholic hydroxyl group, a primary or secondary amino group or an isocyanate group.

4. The aqueous dispersion of claim 1, wherein from 1 to 90% by weight of the polyurethane comprises polysiloxanes of the formula I.

5. The aqueous dispersion comprising a polyurethane of claim 1 further comprising at least one further polymer.

6. A process for preparing an aqueous polyurethane dispersion comprising
reacting polyisocyanates and compounds comprising isocyanate-reactive groups in aqueous miniemulsion, wherein the isocyanate-reactive compounds comprise, at least in part, polysiloxanes of the formula I 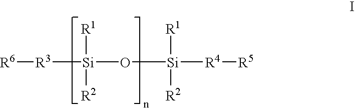
wherein
R¹ and R² independently of one another are a monovalent hydrocarbon radical having not more than 20 carbon atoms, which, optionally, may comprise at least one heteroatom, R³ and R⁴ independently of one another are a single bond or a divalent hydrocarbon radical having not more than 20 carbon atoms, which, optionally, may comprise at least one heteroatom,
R⁵ and R⁶ independently of one another are OH, SH, NH₂ or NHR⁷, wherein R⁷ is a monovalent hydrocarbon radical having not more than 20 carbon atoms, which, optionally, may comprise at least one heteroatom,
and n is an integer from 1 to 100,
thereby obtaining the aqueous polyurethane dispersion.

7. The process of claim 6, wherein the miniemulsion has a monomer droplet size of from 50 to 500 nm.

8. The process of claim 6, wherein the polysiloxanes are prepared by reaction of their starting compounds in situ before, during or after the preparation of the miniemulsion.

9. A method of making a coating composition, adhesive, impregnating composition, sealant, or cosmetic preparation comprising forming the coating composition, adhesive, impregnating composition, sealant, or cosmetic preparation with the aqueous dispersion of claim 1.

10. The aqueous dispersion of claim 1, in the form of a foam stabilizer.

11. The aqueous dispersion of claim 1, wherein R¹ and R², independently of one another, are a monovalent hydrocarbon radical comprising not more than 20 carbon atoms, and also comprise at least one hereroatom.

12. The aqueous dispersion of claim 11, wherein the at least one heteroatom is selected from the group consisting of N, O, and combinations thereof.

13. The aqueous dispersion of claim 1, wherein R³ and R⁴ independently of one another, are a single bond or a divalent hydrocarbon radical comprising not more than 20 carbon atoms, and also comprise at least one heteroatom.

14. The aqueous dispersion of claim 13, wherein the at least one heteroatom is selected from the group consisting of N, O, and combinations thereof.

15. The aqueous dispersion of claim 1, wherein R⁵ and R⁶ independently of one another are OH, SH, NH₂ or NHR⁷, wherein R⁷ is a monovalent hydrocarbon radical comprising not more than 20 carbon atoms, which comprises at least one heteroatom.

16. The aqueous dispersion of claim 15, wherein the at least one heteroatom is selected from the group consisting of N, O, and combinations thereof.

17. The aqueous dispersion of claim 3, comprising further compounds, other than the monomers (a) to (c), comprising at least 2 isocyanate-reactive groups, of which at least one group is a primary or secondary amino group or a mercapto group.

18. The aqueous dispersion of claim 3, comprising monovalent compounds, other than the monomers (a) to (d), comprising a reactive group which is an alcoholic hydroxyl group, a primary or secondary amino group or an isocyanate group.

19. The aqueous dispersion of claim 5, wherein the at least one further polymer is a polymer obtained by free-radical addition polymerization.

20. The aqueous dispersion of claim 1, wherein from 1 to 90% by weight of the polyurethane comprises polysiloxanes of the formula I.
